(19) United States
(12) Patent Application Publication
(10) Pub. No.: US 2026/0322895 A1
(43) Pub. Date: Oct. 15, 2026

(54) ROUTING NETWORK TRAFFIC USING TIME ZONE INFORMATION

(71) Applicant: Microsoft Technology Licensing, LLC, Redmond, WA (US)

(72) Inventors: Jinyang ZHOU, Suzhou, Jiangsu (CN); Rajesh MASKARA, Seattle, WA (US); Zhenguo YANG, Suzhou, Jiangsu (CN); Fangwen YU, Sammamish, WA (US); Todd Carlyle LUTTINEN, Redmond, WA (US); Bradley RUTKOWSKI, Woodinville, WA (US)

(73) Assignee: Microsoft Technology Licensing, LLC, Redmond, WA (US)

(21) Appl. No.: 18/998,773

(22) PCT Filed: Aug. 9, 2022
(86) PCT No.: PCT/CN2022/111156

§ 371 Date: Jan. 27, 2025

(51) Int. Cl. H04L 67/63; H04L 45/121; H04L 61/4511; H04L 67/52

(52) U.S. Cl. CPC H04L 67/63; H04L 45/121; H04L 61/4511; H04L 67/52

(57) ABSTRACT

A DNS request is received from a requesting computing system at a DNS service. The DNS service serves the DNS request by identifying a service endpoint that is closest to the requesting computing system in terms of latency, based on a time zone in which the requesting computing system is located.

### BACKGROUND

Computing systems are currently in wide use. Some such computing systems include hosted systems that host applications or other services over a network and may be referred to as cloud service providers. In some computing systems, client computing systems run browsers or other applications to access hosted applications or other sites.

A domain name system (DNS) is responsible for servicing name resolution requests from users. A user computing system, for instance, may receive a user input identifying a domain name for a website that the user wishes to navigate to. The domain name must be resolved into an internet protocol (IP) address so that the computing system can navigate the user to that IP address to access the desired website. Therefore, when the user enters a domain name into the user's browser, this triggers a DNS lookup. One or more computers known as DNS servers then find the IP address for that domain name and return the IP address to the user's computer so that the user's computer can access the correct website.

To perform a DNS lookup, the user's computer generates a DNS request that contains a request to resolve the domain name into an IP address. The DNS service attempts to serve the DNS request by returning the IP address of the service endpoint that is closest to the user computing system in terms of latency (e.g., that responds to the user or user computing system with the lowest network latency of all the available service endpoints to which the user may be connected). The DNS lookup can be performed using a recursive DNS lookup or an iterative DNS lookup. A recursive DNS lookup is performed when one DNS server communicates with several other DNS servers in order to resolve the domain name into an IP address that can be returned to the client. An iterative DNS lookup is a lookup in which a client communicates directly with each DNS server involved in the lookup, in order to resolve the domain name into the IP address.

The discussion above is merely provided for general background information and is not intended to be used as an aid in determining the scope of the claimed subject matter.

### SUMMARY

A DNS request is received from a requesting computing system at a DNS service. The DNS service serves the DNS request by identifying a service endpoint that is closest to the requesting computing system in terms of latency, based on a time zone in which the requesting computing system is located.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIGS. 2 and 3 show examples of how requests are routed in the computing system architecture shown in FIG. 1, where different user computing systems of a company or organization reside in different time zones.

FIG. 4A is a flow diagram illustrating one example of the operation of the architecture shown in FIG. 1.

FIG. 4B is a flow diagram showing one example of the operation of a DNS service.

FIG. 5 is a data flow diagram illustrating one example of how a routing policy is generated.

FIGS. 6A and 6B (collectively referred to herein as FIG. 6) show a flow diagram illustrating one example of the operation of the elements of the data flow diagram shown in FIG. 5.

FIG. 7 shows one example of a latency array with latency values experienced by a user computing system in accessing a service endpoint.

FIG. 8 shows one example of how the latency array is pre-processed to generate pre-processed data.

FIG. 9 shows one example of how requests can be routed at one time period during the day.

FIG. 10 shows one example of a how requests can be routed at another time period during the day.

FIG. 11 shows one example of the architecture illustrated in FIG. 1 deployed in a cloud computing architecture.

FIG. 12 is a block diagram showing one example of a computing environment.

### DETAILED DESCRIPTION

As discussed above, cloud service providers may have a plurality of front end servers (service endpoints) across a wide-geographic area. The cloud service providers attempt to route end-user requests to closest service endpoints to provide the lowest latency to the end users. The closest service endpoint is often identified based upon the egress internet protocol (IP) address of the public recursive DNS server that the user computing system is using. However, this can result in problems.

Some large companies have office locations in different geographic areas. The computing systems at these disparate locations often use a shared public recursive DNS server, which can result in sub-optimal routing for one or more of the company's computing systems.

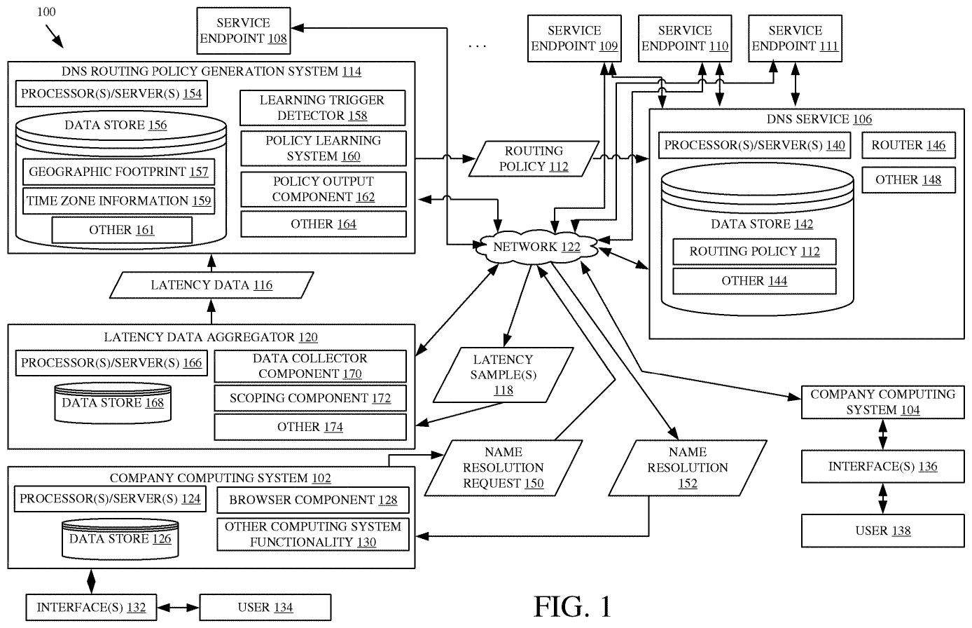

For instance, a company (or other organization) may have a geographic footprint in which offices with user computing systems are located in different time zones. Yet, those computer systems may share the same DNS service. Therefore, the DNS service resolves a domain name by finding the service endpoint that is closest (in terms of latency) to the egress IP address from the shared DNS service. However, where the company computing systems are located in different time zones, this can result in requests being routed to service endpoints that may be optimal for one of the company computing systems in one time zone, but is suboptimal for another company computing system in another time zone. This is described in greater detail below with respect to FIGS. 1-3.

Therefore, the present description describes a system in which routing policies are generated by considering the geographic footprint of a company computing system architecture and the time zones of offices with company computing systems that are generating requests. A customized mapping table can be generated for each company computing system so that during certain time periods of the day, requests may be forced to one service endpoint or another, while conventional routing policies may be used to route the requests during other times of the day. Such time zone-based network routing policies can be generated using historical data or using real time data (or near real time data). The present system can also generate the routing policies utilizing other attributes, such as local or public DNS IP address, client IP address, client-browser version, etc.

FIG. 1 is a block diagram of one example of a company computing system architecture 100 in which a plurality of company computing systems 102-104 may be systems of a single company, but located in different geographic locations (such as in different time zones). Company computing system 102-104 provide DNS requests to a DNS service 106 which, itself, resolves each of those requests by returning an IP address of a service endpoint, out of a plurality of different service endpoints 108, 109, 110, and 111. In serving the DNS requests, DNS service 106 uses a routing policy 112 to pick the closest service endpoint to the requesting computing system, and the routing policy 112 is generated by a DNS routing policy generation system 114. In generating the routing policy 112, DNS routing policy generation system 114 uses latency data 116 that is aggregated from a number of latency samples 118 by latency data aggregator 120. The DNS routing policy generation system 114 also uses the geographic footprint of the company showing the locations of the company computing systems 102-104, as well as time zone information indicating which time zones the company computing systems 102-104 are located in. The latency samples 118 may be aggregated from latency data that is reported by, or acquired from, company computing systems 102-104 over a long period of time or in near real time.

The various items in architecture 100 may communicate over network 122. Therefore, network 122 can be a wide area network, a local area network, a near field communication network, a cellular network, or any of a wide variety of other networks or combinations of networks. Before describing the operation of computing system architecture 100 in more detail, a description of some of the items in architecture 100, and their operation, will first be provided.

Company computing systems 102-104 may be similar or different. For purposes of the present discussion, it will be assumed that they are similar so that only company computing system 102 is described in more detail. In the example shown in FIG. 1, company computing system 102 includes one or more processors or servers 124, data store 126, browser component 128, and other computing system functionality 130. Company computing system 102 is also shown generating interface(s) 132 for interaction by user 134. User 134 interacts with interface(s) 132 in order to control and manipulate company computing system 102 and possibly other portions of architecture 100. FIG. 1 also shows that company computing system 104 generates interface(s) 136 for interaction by user 138. User 138 can interact with interface(s) 136 in order to control and manipulate company computing system 104 and some other portions of architecture 100.

DNS service 106 includes one or more processors or servers 140, data store 142 (which may store routing policy 112 and other items 144), router 146, and other items 148. When one of the company computing systems 102-104 needs to have a domain name resolved to its corresponding IP address, the company computing system generates a DNS request. For purposes of the present discussion, it will be assumed that company computing system 102 generates a DNS request 150. Request 150 is provided to DNS service 106. Router 146 attempts to serve the DNS request 150 by returning an IP address of a service endpoint 108-111 that is closest to company computing system 102 in terms of network latency. In order to serve the DNS request, router 146 illustratively accesses the routing policy 112 which maps different company computing system subnetworks (i.e., it is assumed that company computing system 102 belongs to one of those subnetworks) to a service endpoint 108-111 that is closest to that subnetwork in terms of latency. Therefore, router 146 identifies the client subnetwork (or other address) that DNS request 150 originated from and accesses routing policy 112 to identify the service endpoint 108-111 that is closest, in terms of network latency, to the identified client subnetwork (or other address). Router 146 then returns the IP address that can be used to navigate to the identified service endpoint 108-111.

DNS routing policy generation system 114 may include one or more processors or servers 154, data store 156, learning trigger detector 158, policy learning system 160, policy output component 162, and other items 164. Data store 156 may include geographic footprint data 157, time zone information 159, and other information 161. Geographic footprint data 157 may indicate the geographic locations of the different company computing systems 102-104, while time zone information 159 may indicate which time zones the company computing systems 102-104 are located in. Learning trigger detector 158 may detect when it is time for learning system 160 to perform learning in order to generate a new or modified routing policy 112 for DNS service 106. In one example, learning trigger detector 158 may detect an input from DNS service 106 (or elsewhere) requesting an updated routing policy 112, as the trigger to perform learning. In another example, learning trigger detector 158 may detect that a triggering time period has elapsed since policy 112 was last generated or modified so that learning system 160 is to learn a modified routing policy 112. In yet another example, it may be that a threshold number or volume of latency data samples have been collected and that is used as the trigger to control learning system 160 to perform learning. In another example, routing policies are being modified in real time or in near real time so learning trigger detector 158 is not needed.

Policy learning system 160 performs learning based on latency data 116 that is received from latency data aggregator 120, in order to generate routing policy 112.

In one example, learning system 160 accesses the geographic footprint data 157 that identifies the locations of company computing systems 102-104. Learning system 160 uses time zone information 159 to identify the time zone where each system 102-104 is located. Learning system 160 can also use other information 161, such as the version of browser component 128 or other information. Based on this information, learning system 160 generates policy 112, which may be a customized mapping table, as discussed elsewhere, that maps computing system 102 to a different one of the service endpoints 108-111 during different times of day. Policy output component 162 outputs the routing policy 112 for use by DNS service 106.

Latency data aggregator 120 can include one or more processors or servers 166, data store 168, data collector component 170, scoping component 172, and other items 174. Latency data aggregator 120 aggregates the latency data samples 116 from company computing systems 102-104 or company computing system subnetworks. Data collector component 170 aggregates the latency samples 118 and scoping component 172 can further aggregate them based on user scoping parameters. For instance, it may be that the latency samples 118 may be aggregated over a geographic area scope of users, or samples 118 may be aggregated over autonomous system numbers (ANS) to which users belong, or in other ways. Thus, the average latency of a set of latency samples 118 may be aggregated based on the user scoping parameters by scoping component 172.

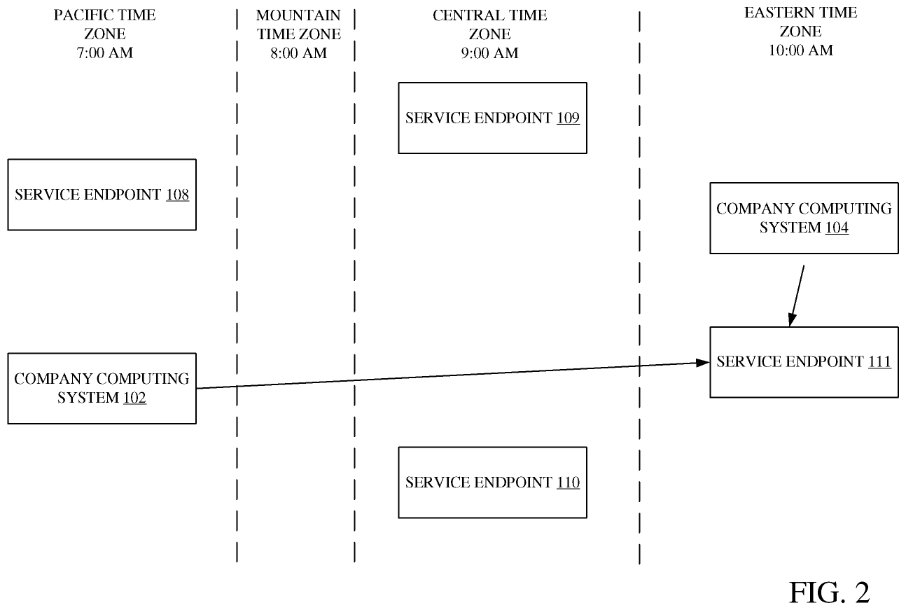

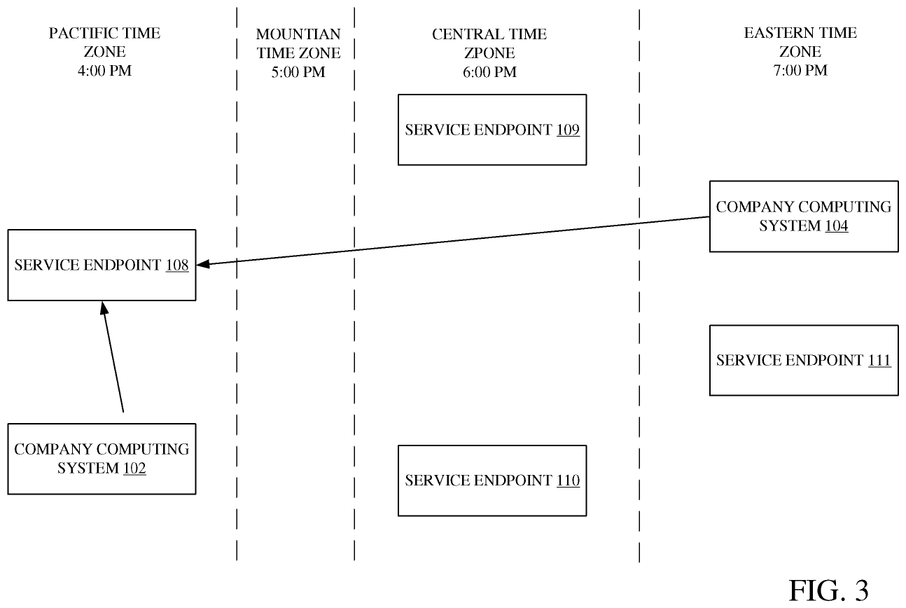

Before describing the overall operation of architecture 100 in more detail, FIGS. 2 and 3 will be described which illustrate some of the problems encountered when the company computing systems 102-104 are located in geographically different locations and in which the service endpoints 108-111 are also distributed across multiple different geographic locations.

FIG. 2 is a block diagram showing some portions of the computing system architecture 100 (shown in FIG. 1) in which company computing systems 102 and 104, as well as service endpoints 108-111 are located across multiple different time zones. In the example shown in FIG. 2, company computing system 102 is a company computing system located at a company office in the pacific time zone in the United States of America. Company computing system 104 is a company computing system located at a company office, which is an office of the same company as computing system 102, but located in the eastern time zone in the United States of America. FIG. 2 also shows that service endpoint 108 is located in the pacific time zone while service endpoints 109 and 110 are located in the central time zone and service endpoint 111 is located in the eastern time zone. FIG. 2 also shows that, in the example illustrated, it is 7:00 am on the west coast and 10:00 am on the east coast. Therefore, in the example shown in FIG. 2, it is likely that most workers for the company in the East coast office (and thus users of company computing system 104) are at work, because it is 10:00 am. However, it is also likely that most workers that in the West coast office (and thus users of company computing system 102) are not at work, because it is 7:00 am. This means that the company computing system 104 will be generating a much larger number of domain name requests that are to be resolved by DNS service 106. Than the number of requests that will be generated by company computing system 102. The collective average latency experienced by the two company computing systems 102-104 is thus likely to be much lower for requests routed to service endpoint 111, which is closest to company computing system 104, because most of the requests generated by the company are generated by the company computing system 104 on the East coast. This means that the requests generated by the company computing system 102 (on the West coast) will be routed to service endpoint 111 as well, even though the latency might be much lower if those requests were routed to service endpoint 108.

FIG. 3 is similar to FIG. 2, and similar items are similarly numbered. However, in FIG. 3, it is now 4:00 μm on the West coast and 7:00 μm on the East coast. This means that there are likely more name resolution requests being generated by the company computing system 102 than there are generated by the company computing system 104, because most users on the West coast will still be at work while most users on the East coast will not be at work. Therefore, the collective average latency of all requests generated by the company computing system 102-104 will likely show that the latency to service endpoint 108 is lower than the latency to service endpoint 111. Name resolution requests from both company computing systems 102 and 104 of the company will be routed to service endpoint 108, even though the latency for company computing system 104 would likely be lower if the requests were directed to the East coast service endpoint 111 on the East coast.

The present description thus describes a system which considers the particular time zone where the company computing systems 102 and 104 are located and generates a customized mapping table for each of the computing systems 102 and 104 so that the mapping table may be used to generate a network routing policy 112 so that, during certain times of the day, the requests from each of the company computing systems 102 and 104 may be routed to different service endpoints, at different times of the day.

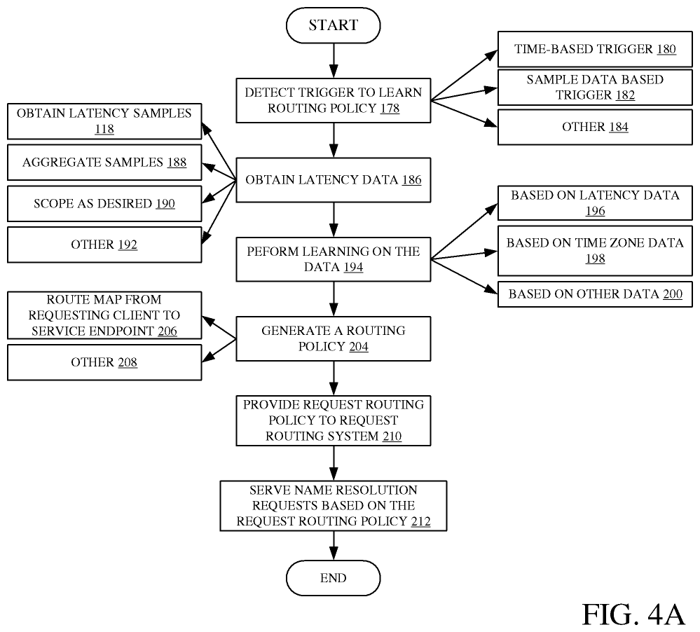

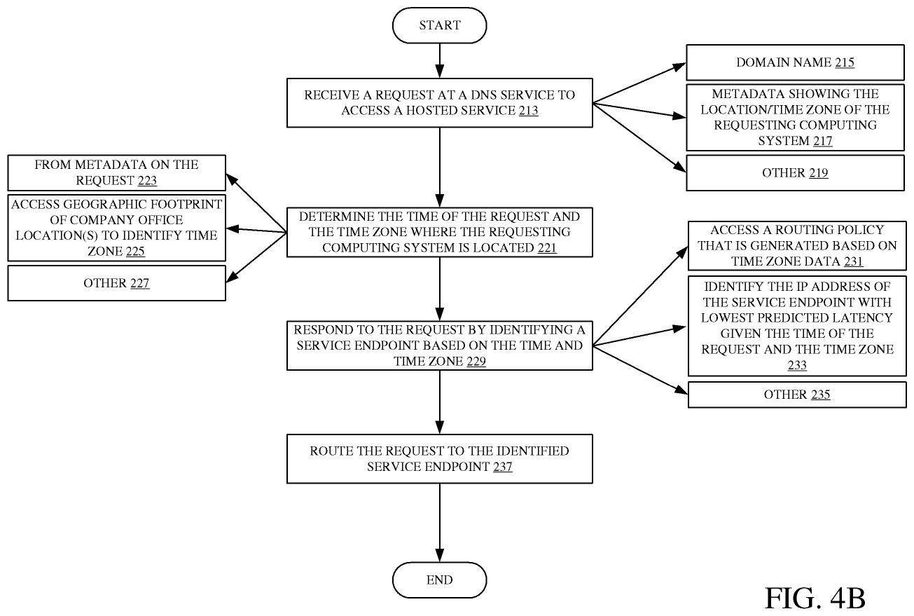

FIG. 4A is a flow diagram illustrating one example of the operation of computing system architecture 100. At some point, learning trigger detector 158 detects a trigger indicating that learning system 160 is to learn or generate a routing policy 112 based upon latency data 116 and based on the time zone in which each company computing system 102-104 resides, and optionally based on other information as well. Detecting the trigger to perform learning is indicated by block 178 in the flow diagram of FIG. 4A. As discussed above, the trigger can be a time-based trigger 180, a sample data volume based trigger 182, or another trigger 184. Learning system 160 then obtains latency data 116, as indicated by block 186 in the flow diagram of FIG. 4A. The latency data can be latency samples 118 or aggregated samples 188. The samples can be scoped, as desired, as indicated by block 190. The latency data can be obtained in other ways as well, as indicated by block 192.

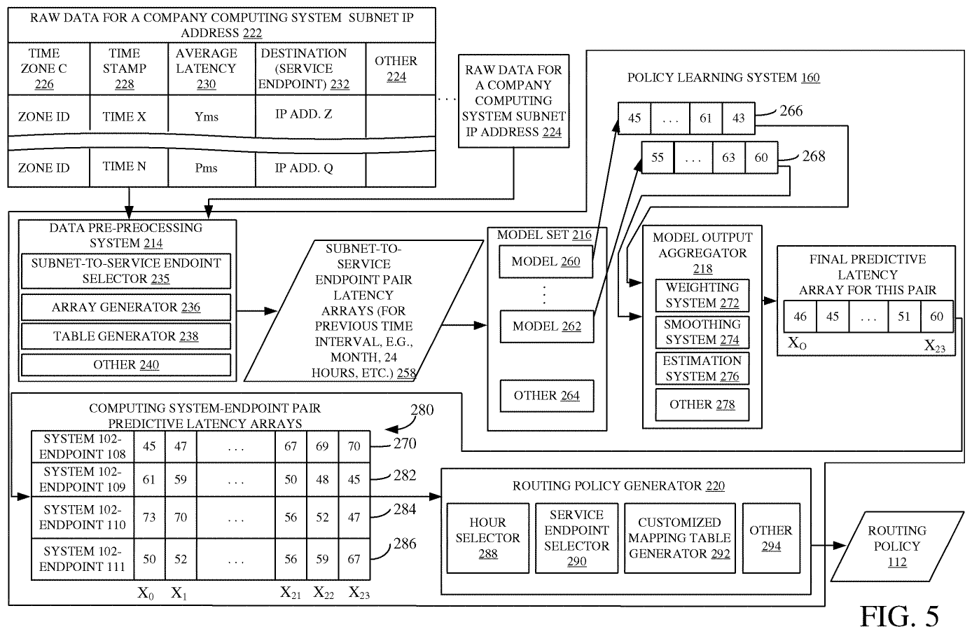

Policy learning system 160 then performs learning to generate a routing policy 112 as indicated by block 194. The learning can be performed based on the latency data as indicated by block 196 and the time zone data as indicated by block 198 and other data as indicated by block 200. Learning system 160 can implement a reinforcement learning algorithm, or learning can be performed in other ways as well, as indicated by block 202. One example of how learning is performed is described in greater detail below with respect to FIGS. 5-8.

Learning system 160 generates a routing policy 112 which is output by policy output component 162, as indicated by block 204 in the flow diagram of FIG. 4A. The routing policy 112 can be a route map that maps a company computing system 102-104 to a service endpoint 108-111, as indicated by block 206. The routing policy can be generated and output in other ways as well, as indicated by block 208. The route map may, for example, be a customized mapping table that maps the IP subnet addresses for each company computing system 102-104 to one of a plurality of different service endpoints 108-111 during different times of the day, based on the time zone where the company computing system 102-104 is located. Policy output component 162 then provides the routing policy 112 to DNS service 106, as indicated by block 210 in the flow diagram of FIG. 4A. Router 146 in DNS service 106 then serves the name resolution requests from company computing systems 102-104 by resolving the domain names in the requests to IP addresses of the service endpoints 108-111 using the routing policy 112, as indicated by block 212 in the flow diagram of FIG. 4A. This continues until trigger detector 158 detects that it is time to update the routing policy 112, or generate another routing policy, at which time processing continues at block 186.

FIG. 4B is a flow diagram showing one example of the operation of the DNS service 106. DNS service receives a DNS request from company computing system 102 which is attempting to access a hosted service which has front ends at service endpoints 108-111, as indicated by block 213. The request may include a domain name 215 and metadata 217 showing the location and/or the time zone where the company computing system 102 is located. The request can include other information 219 as well.

Router 146 can determine the time of the request and the time zone from which the request was received (where the requesting computing system is located) as indicated by block 221. The time and time zone can be obtained from the metadata on the request, as indicated by block 223. The time zone can be identified by accessing the geographic footprint 157 of the company, as indicated by block 225, or in other ways, as indicated by block 227.

Router 146 responds to the request by identifying one of the service endpoints 108-111 that is closest to company computing system 102 in terms of network latency, as indicated by block 229. The service endpoint can be identified by accessing a routing policy 112 that is generated based on time zone, as indicated by block 231. The service endpoint can be identified by returning the IP address of the service endpoint with the lowest latency with respect to company computing system 102, given the time of the request and given the time zone where computing system 102 is located, as indicated by block 233, or in other ways, as indicated by block 235. The request is then routed to the identified service endpoint, as indicated by block 237.

FIG. 5 is a data flow diagram showing one example of the operation of learning system 160 in generating routing policy 112 based on latency data 116 collected from latency samples 118 (shown in FIG. 1) and based on time zone data. FIG. 5 shows that learning system 160 includes data pre-processing system 214, model set 216, model output aggregator 218 and routing policy generator 220. Data pre-processing system 214 includes subnet-to-service endpoint selector 235, array generator 236, table generator 238, and other items 240. Model set 216 includes a plurality of different models 260-262 and other items 264. Model output aggregator 218 includes weighting system 272, smoothing system 274, estimation system 276, and other items 278. Routing policy generator 220 includes hour selector 288, service endpoint selector 290, customized mapping table generator 292, and other items 294.

FIG. 5 shows data pre-processing system receiving data 222-224 which comprises latency data from different company computing systems 102-104. For instance, data 222 may be latency samples 118 identifying the network latency observed at company computing system 102 when system 102 is attempting to access different service endpoints 108-111. Data 224 may be latency samples identifying the latency observed by company computing system 104 when attempting to access different service endpoints 108-111.

In the example shown in FIG. 5, data sets 222-224 may be similar or different. They are assumed to be similar for the sake of the present discussion so that only data 222 is discussed in more detail. Data 222 includes latency information for different requests generated by company computing system 102. The data can include time zone information 226 that identifies a particular geographic time zone where company computing system 102 is located. The time zone data can be obtained using geographic footprint 157 and time zone information 159 or in other ways. The data 222 can include a timestamp 228 that identifies a time when the corresponding request was generated, average latency data 230 that identifies the average latency encountered over a time period using the time identified in timestamp 228), and destination information 232 that, for instance, identifies the IP address of the particular service endpoint 108-111 where the request was sent. Data 222 can include other data 234, such as the version of browser component 128 being used by company computing system 102, or other data.

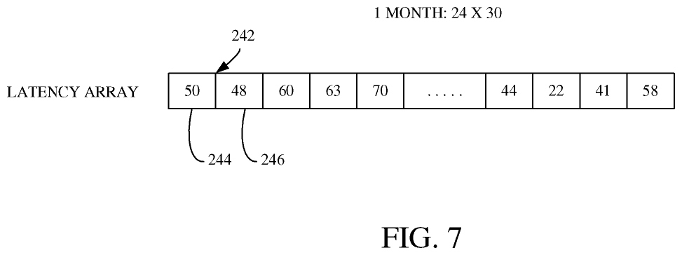

Array generator 236 in data pre-processing system 214 generates an array of latency values, aggregated over different time intervals, for an overall time period, for each subnet address of the company computing systems 102-104. FIG. 7 shows one example of a latency array 242. The latency array 242 is generated for a pair in which one element of the pair is the subnet IP address of a company computing system 102 and the other element of the pair is one of the service endpoints 108-111. These different pairs are referred to herein as subnet-to-service endpoint pairs.

The subnet-to-service endpoint pairs can be identified in a wide variety of different ways. For instance, the pairs can be identified based on the IP address of the subnet used by the company computing system 102 and the IP address of the service endpoint. The pairs can be identified based on the egress IP address of the local DNS server used by the company computing system 102 and the IP address of the service endpoint. The subnet-to-service endpoint pairs can be identified in other ways as well.

Therefore the pair of company computing system 102 and service endpoint 108 may have one array such as array 242 shown in FIG. 7. The subnet-to-service endpoint pair of company computing system 102 and service endpoint 109 may have another array. The same is true for the company pair comprising company computing system 102 and service endpoint 110, and the pair comprising company computing system 102 and service endpoint 111. A similar set of latency arrays can also be generated for subnet-to-service endpoint pairs that pair company computing system 104 with each of the service endpoints 108-111.

In the example shown in FIG. 7, latency array 242 is a latency array generated for the subnet-to-service endpoint pair comprising company computing system 102 and service endpoint 108. Each element in latency array 242 contains a value representing the average latency encountered by a company computing system 102 when attempting to access service endpoint 108 over a particular hour of the day. Latency array 242 represents 30 days worth of data. Therefore, there are 720 (30 days×24 hours) elements or cells in array 242, each representing the average latency experienced by company computing system 102 when attempting to access service endpoint 108 at the particular hour of the particular day represented by that element or cell in the array. By way of further example, the first element 244 in latency array 242 shows that company computing system 102 experienced an average of 50 milliseconds in latency when sending a request to service endpoint 108 during the first hour of the month for which array 242 was generated. Array element or cell 246 shows that company computing system 102 experienced an average of 48 milliseconds in latency when attempting to access service endpoint 108 during the second hour of the month.

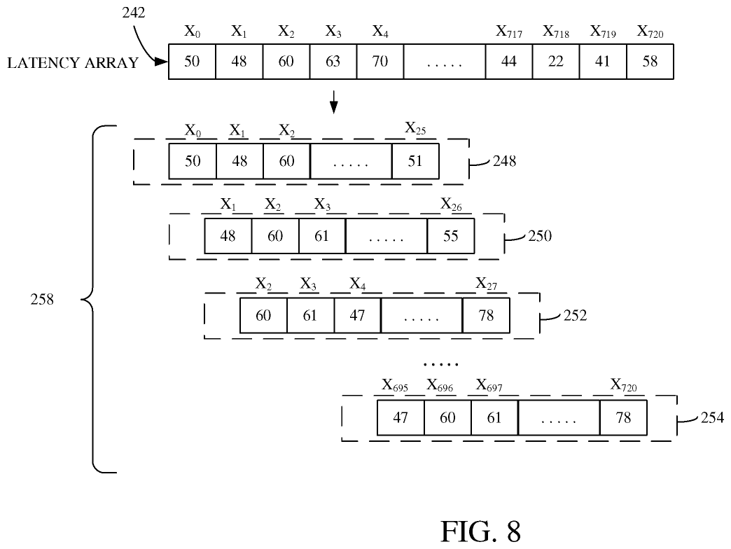

Table generator 238 can then process the latency array 242 to generate a plurality of smaller arrays each representing a smaller amount of time. FIG. 8 shows that latency array 242 can be broken into a set of smaller arrays 248, 250, 252-254. Each of the smaller arrays represents a window of array elements (in the example shown in FIG. 8 each of the smaller arrays 248, 250, 252, and 254 represents a window of 26 array elements. The window, however migrates to the right by one cell across array 242 and, with each migration step, a new array 248-254 is generated. The arrays 248-254 are all generated for the single subnet-to-service endpoint pair comprising company computing system 102 paired with service endpoint 108. These subnet-to-service endpoint pair latency arrays are collectively illustrated by number 258 in FIG. 8 and by the block 258 in the diagram of FIG. 5.

The collection of arrays 258 is then fed into a set of models 216. The model set 216 can include a plurality of different models 260-262. Model set 216 can include other items 264 as well. The different models 260-262 may process the arrays 258 in different ways to generate different outputs that are predictive of the latency that will be experienced by company computing system 102 when accessing service endpoint 108 over a future time period. For instance, model 260 may be a Bayesian classifier while model 262 is a deep learning system, such as a deep neural network, or another type of model, such as a model that runs a reinforcement learning algorithm. Each of the models 260-262 generates a preliminary predictive output, such as a preliminary predictive array. For example, model 260 generates preliminary predictive array 266 while model 262 generates preliminary predictive array 268. Each of the preliminary predictive arrays may predict the latency that will be experienced by company computing system 102 over a future time interval, such as over the next 24 hours. By way of example, the cells in array 266 may each represent the predicted average latency that will be experienced over a different hour in the next 24 hour period.

The preliminary predictive arrays 266-268 that are output by the different models 260-264 are provided to model output aggregator 218 which aggregates the different predictive models 266-268 in order to obtain a single (e.g., final) predictive latency array for the subnet-to-service endpoint pair for which the preliminary predictive arrays 266-268 were generated. The single predictive latency array output by model output aggregator 218 is represented by final predictive latency array 270. In generating final predictive latency array 270, model output aggregator 218 may employ a weighting system 272, a smoothing system 274, an estimation system 276, and other systems 278. Weighting system 272 may apply weights to the values in each of the preliminary predictive arrays 266-268 output by models 260-262. Smoothing system 274 may smooth the outputs (such as where aberrant values are identified in the different array cells), and estimation system 276 can generate the final predictive latency array 270 based upon the smoothed, weighted values from the preliminary predictive arrays 266-268. In one example, for instance, estimation system 276 generates the final predictive latency array 270 as the weighted average of the smoothed latency values in the different preliminary predictive arrays 266-268 output by models 260-262.

The process of performing data pre-processing using data pre-processing system 214, generating preliminary predictive latency arrays using model set 216, and outputting a final predictive latency array 270 is performed for each of the subnet-to-service endpoint pairs which comprise company computing systems 102-104 paired with the different service endpoints 108-111.

For each company computing system 102, then, a set 280 of final predictive latency arrays is generated and provided to routing policy generator 220. The set of final predictive latency arrays 280 are the final predictive latency arrays 270 generated by model output aggregator 218 for each subnet-to-service endpoint pair for a selected company computing system. For instance, the set of final predictive latency arrays 280 include a first array 270 that is the final predictive latency array for the pair of company computing system 102 and endpoint 108. The set of arrays 280 also includes array 282 that is the final predictive latency array for the pair comprising company computing system 102 and service endpoint 109. The set of arrays 280 also includes array 284 that is the final predictive latency array for the pair comprising company computing system 102 and service endpoint 110. The set of arrays 280 also includes array 286 that is the final predictive latency array for the pair comprising company computing system 102 and service endpoint 111. All of these predictive latency arrays are provided to routing policy generator 220.

Routing policy generator 220 then identifies, for each hour represented by the set of arrays 280, which array has an array element with the lowest latency. The service endpoint corresponding to that array is selected and used to generate a routing policy 212 that will route the company computing system 102 to that service endpoint during that hour within the next 24 hour period. Therefore, routing policy generator 220 includes hour selector 288, service endpoint selector 290, customized mapping table generator 292, and it can include other items 294.

Hour selector 288 selects an hour for analysis. Assume, for instance, that the hour X₀ is selected. In the present example, service endpoint selector 290 identifies which latency array 270, 282, 284, or 286 has the lowest latency value during hour X₀. Service endpoint selector 290 will identify array 270 as having the lowest latency value at hour X₀. Service endpoint selector 290 then determines which service endpoint 108-111 the array 270 was generated for. That service endpoint will be the one with the lowest predicted latency for company computing system 102 during hour X₀. Thus, service endpoint selector 290 identifies service endpoint 108 because it has the lowest predictive latency during hour X₀ for company computing system 102.

Hour selector 288 then selects the next (hour X₁) and service endpoint selector 290 identifies the service endpoint which has the lowest predicted latency during hour X₁ (again it is service endpoint 108 in the present example). This continues for each hour until hour selector 288 has selected the last hour X₂₃ and service endpoint selector 290 has identified the service endpoint (in this case service endpoint 109) which has the lowest predicted latency for hour X₂₃.

All of the selected service endpoints selected by service endpoint selector 290, along with the particular hour they were selected for, are output from service endpoint selector 290 to customized mapping table generator 292 which generates a customized mapping table for company computing system 102. The customized mapping table may be output as routing policy 112. One example of a customized mapping table for company computing system 102 is shown in Table 1 below.

TABLE 1
COMPANY COMPUTING SYSTEM MAPPING TABLE

| | |
|---|---|
| 00:00-0600 | SERVICE ENDPOINT X |
| 06:00-12:00 | SERVICE ENDPOINT Z |
| 12:00-18:00 | SERVICE ENDPOINT Y |
| 18:00-00:00 | OTHER ROUTING POLICY |

Table 1 shows that for the hours between midnight and 6:00 am, based upon the particular service endpoints selected by service endpoint selector 290, company computing system 102 will be routed to a particular service endpoint (service endpoint X in Table 1). Between the hours of 6:00 am and noon, company computing system 102 will be routed to service endpoint Z, and in the hours between noon and 6:00 μm, company computing system 102 will be routed to service endpoint Y. Between the hours of 6:00 μm and midnight, it may be that the router 146 accesses a different routing policy or uses other routing rules to route the company computing system 102 to a service endpoint based upon different criteria. The customized mapping table shown in Table 1 is just one example of routing policy 112 and other examples of mapping tables or other forms of routing polices can be generated, such as where the hours are different or the service endpoints are routed based on different criteria, etc.

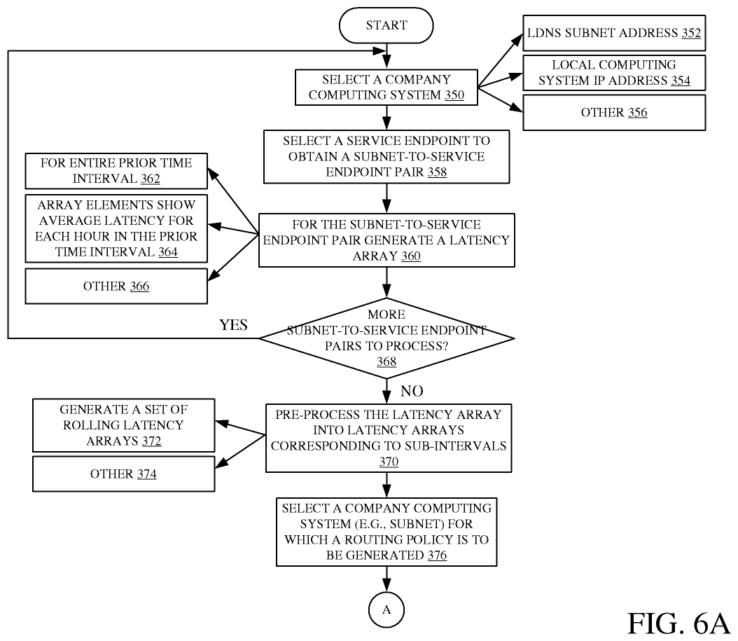

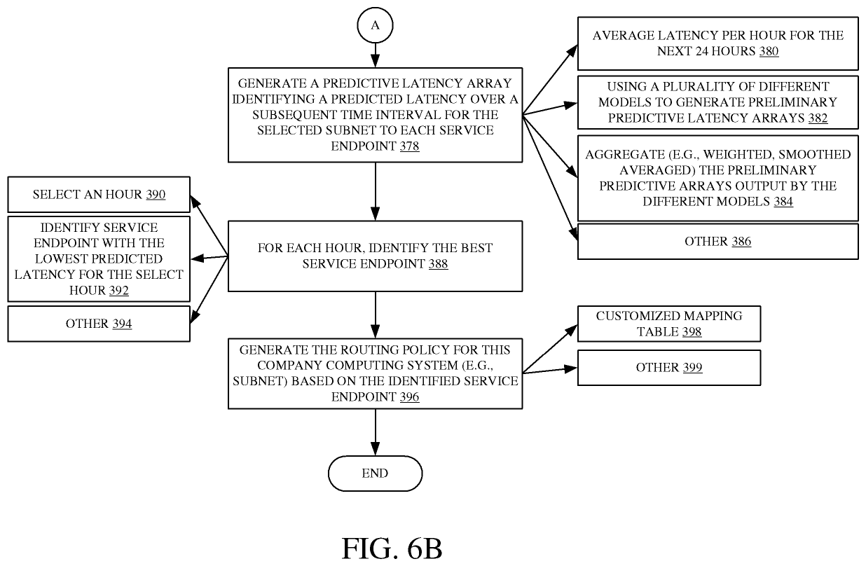

FIGS. 6A and 6B (collectively referred to herein as FIG. 6) show a flow diagram illustrating one example of the operation of policy learning system 160 in more detail. Subnet-to-service endpoint selector 235 in data pre-processing system 214 first selects a company computing system subnet IP address for processing, as indicated by block 350 in the flow diagram of FIG. 6. The selector 235 may identify the selected company computing system by the LDNS subnet IP address, as indicated by block 352. The selector 235 may select the company computing system 102 based on the local computing system IP address, as indicated by block 354. The selector 235 can select the company computing system 102 in other ways as well, as indicated by block 356.

Subnet-to-service endpoint selector 235 then selects a service endpoint to obtain a subnet-to-service endpoint pair comprising the selected company computing system and the selected service endpoint. Obtaining the subnet-to-service endpoint pair is indicated by 358 in the flow diagram of FIG. 6. Then, for the subnet-to-service endpoint pair, array generator 236 generates a latency array, as indicated by block 360 in the flow diagram of FIG. 6. The latency array may be a latency array such as array 242 shown in FIG. 7, which is generated for a prior time interval (in the case of array 242, the prior time interval is 1 month) as indicated by block 362. In the example described herein, the array elements show the average latency for each hour in the prior time interval, as indicated by block 364. This, of course, is an example only and the array elements may show the average latency for longer or shorter time periods as well. The latency array may be generated in other ways (such as in near real time) as well, as indicated by block 366.

Subnet-to-service endpoint selector 235 then determines whether there are more subnet-to-service endpoint pairs for which a latency array is to be generated, as indicated by block 368. If so, processing reverts to block 350 where selector 235 selects a company computing system and a service endpoint to obtain another subnet-to-service endpoint pair. However, if, at block 368, the subnet-to-service endpoint pairs have all been generated and had latency arrays generated therefore, then processing continues at block 370. For example, as described above with respect to FIG. 8, table generator 238 can divide the latency array 242 into a set of rolling latency arrays 258. Generating a set of rolling latency arrays is indicted by block 372 in the flow diagram of FIG. 6. The latency array 242 can be divided or processed in any of a wide variety of other ways into different types of sub-arrays or other pre-processed data structures, as indicated by block 374.

Model set 216 then selects a company computing system (e.g., a subnet) for which a routing policy 212 is to be generated. Selecting the company computing system (or subnet) is indicated by block 376 in the flow diagram of FIG. 6. Model set 216 and model output aggregator 218 then generate a final predictive latency array that predicts the latency to be encountered by the selected company computing system over a future (e.g., subsequent) time interval. The final predictive latency array may be a set of arrays such as the latency arrays 280 shown in FIG. 5. Generating the final predictive latency array is indicated by block 378 in the flow diagram of FIG. 6. The final predictive latency arrays may have array elements that each show the average latency, for a given hour, for the next twenty-four hours, as indicated by block 380. The final predictive latency array 280 may be generated by using a plurality of different models (such as those shown in model set 216) as indicated by block 382, to generate preliminary predictive arrays 266-268 and then combining or aggregating the preliminary predictive arrays 266-268 using model output aggregator 218 (such as by weighting, smoothing, averaging, etc.), as indicated by block 384. The predictive output 280 can be generated in other ways as well, as indicated by block 386.

Then, routing policy generator 220 identifies the best service endpoint for each corresponding set of array elements in output 280 (e.g., for each hour), as indicated by block 388 in the flow diagram of FIG. 6. To do so, hour selector 288 selects an hour (or a set of array elements from arrays 280 corresponding to the same hour), as indicated by block 390. Service endpoint selector 290 then identifies the service endpoint (for the selected hour) with the lowest predictive latency for the selected hour, as indicated by block 392. The best service endpoint can be selected in other ways as well, as indicated by block 394.

Routing policy generator 220 then generates the routing policy 112 for this company computing system (e.g., subnet) based upon the identified service endpoints, identified by service endpoint selector 290, as indicated by block 396 in the flow diagram of FIG. 6. The routing policy 112 thus identifies, for each hour (or other time period) in the predicted future time interval (e.g., the next twenty-four hours), the best service endpoint in terms of latency for the currently selected company computing system. The policy can be formed as a customized mapping table 398 that can be generated by customized mapping table generator 292. As discussed above, Table 1 shows one example of a customized mapping table. There may be one customized mapping table for each company computing system in a customer's computing system architecture. The routing policy 112 can be generated in other forms or in other ways as well, as indicated by block 399 in the flow diagram of FIG. 6.

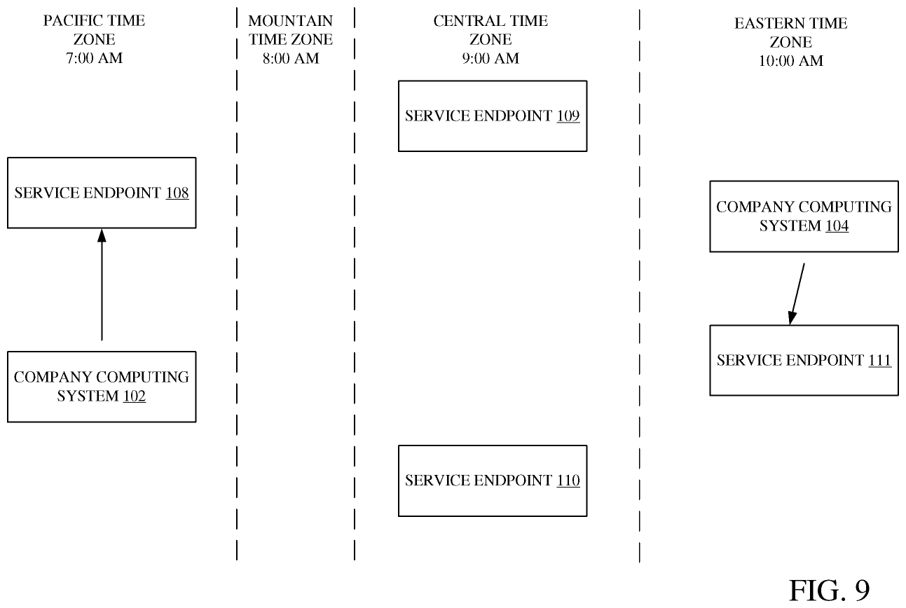

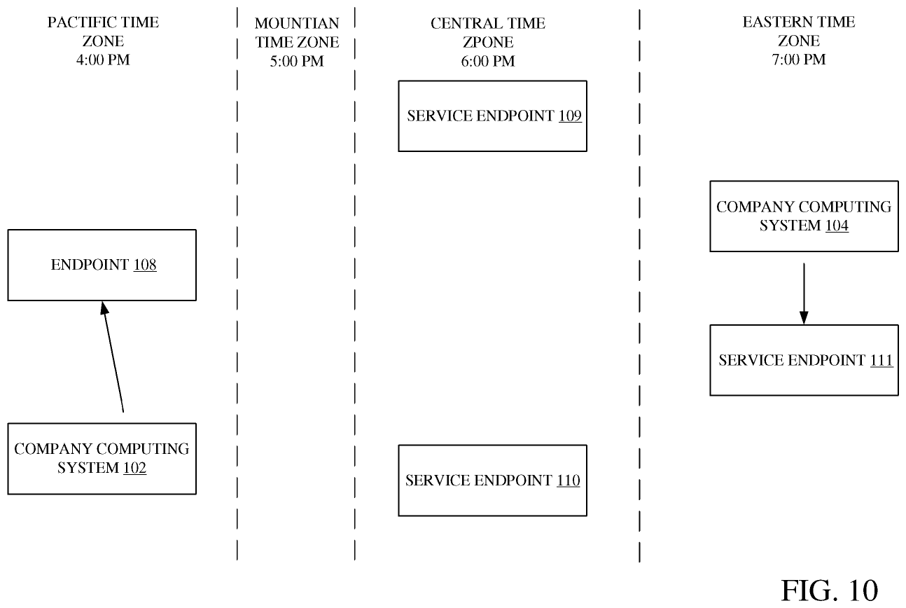

FIGS. 9 and 10 are similar to FIGS. 2 and 3, and similar items are similarly numbered. However, FIGS. 9 and 10 show one example of how generating a routing policy using the present description can decrease latency in accessing service endpoints. FIG. 9 shows that it is 7:00 am in the time zone where computing system 102 resides and 10:00 am in the time zone where computing system 104 resides. Instead of both computing systems 102 and 104 accessing service endpoint 111 (as was illustrated in FIG. 2), the request from computing systems 102 and 104 are routed based on custom routing policies 112 that are customized for each computing system 102 and 104.

Recall that in FIG. 2, both computing systems 102 and 104 sent requests to service endpoint 111, because the overall average latency to service endpoint 111 from computing systems 102 and 104 was the lowest. However, this was because the large majority of the requests were generated by computing system 104, since it was 10:00 am at the location of computing system 104 and more workers are at work. The time zone of computing system 102, however, was at 7:00 am so fewer workers were generating requests and thus even if the requests generated by computing system 102 had longer latency when directed to service endpoint 111, the longer latency was lowered on average by the larger number of requests generated by computing system 104. However, when the requests for each computing system 102 and 104 are routed based upon a customized routing policy 112 the predictive latency during different times of the day is generated so that the individual computing systems 102 and 104 will have requests routed to different service endpoints. Computing system 102 may have a customized routing policy which dictates that requests are routed to service endpoint 108 at 7:00 am, while computing system 104 has a customized routing policy that dictates that requests will be routed to service endpoint 111 at 7:00 am in its time zone. Thus, both computing systems 102 and 104 will encounter a lower latency, regardless of the time of day.

FIG. 10 is similar to FIG. 3, and similar items are similarly numbered. In FIG. 10, the west coast time zone is at 4:00 μm while the east coast time zone is at 7:00 μm. Therefore, there are more workers at the office of computing system 102 than at the office of computing system 104. Thus, during that hour, it may also be advantageous (in terms of latency) to have all requests from computing system 104 routed to East coast service endpoint 111, rather than West coast service endpoint 108 (which will be more congested, because of the time of day).

It can thus be seen that, because the routing policy considers the time of day, time zone, and possibly other information, rules can be dynamically generated, due to changing network conditions, to generate a custom routing policy for each company office location. During certain times of the day, the policy can dictate that requests are sent to a particular service endpoint while at other times of the day, different rules or different criteria can be used in deciding where to route the requests. This reduces latency encountered by different office locations in a computing system architecture.

It will be noted that the above discussion has described a variety of different systems, components, processors, generators, aggregators, and/or logic. It will be appreciated that such systems, components, processors, generators, aggregators, and/or logic can be comprised of hardware items (such as processors and associated memory, processors executing computer readable instructions, or other processing components, some of which are described below) that perform the functions associated with those systems, components and/or logic. In addition, the systems, components, processors, generators, aggregators, and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components, processors, generators, aggregators, and/or logic described above. Other structures can be used as well.

The present discussion has mentioned processors and servers. In one example, the processors and servers include computer processors (e.g., central processing units) with associated memory and timing circuitry, not separately shown. The processors and servers are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which they are displayed is a touch sensitive screen, the mechanisms can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

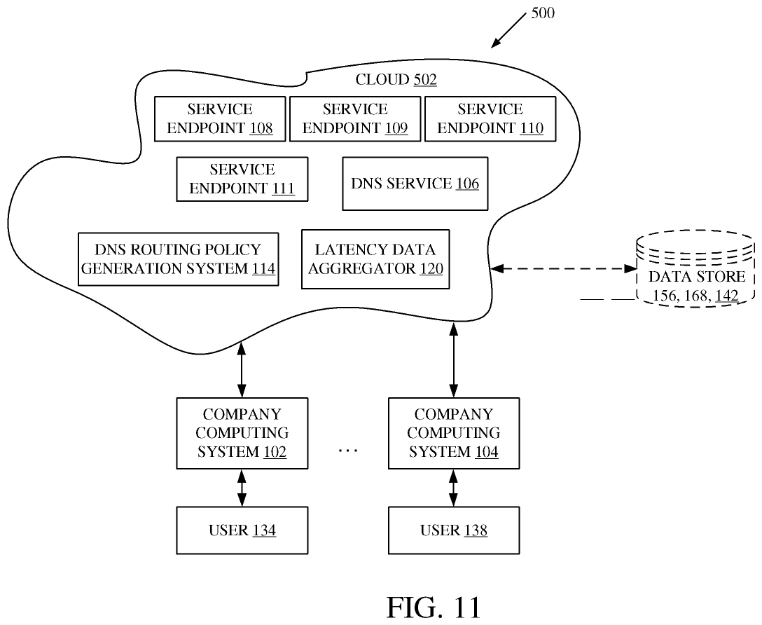

FIG. 11 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 11, some items are similar to those shown in FIG. 1 and they are similarly numbered. FIG. 11 specifically shows that service endpoints 109-111, DNS routing policy generation system 114, DNS service 106, and latency data aggregator 120 can be located in cloud 502 (which can be public, private, or a combination where portions are public while others are private). Therefore, users 134 and 138 use systems 102-104 to access those systems through cloud 502.

FIG. 11 also depicts another example of a cloud architecture. FIG. 11 shows that it is also contemplated that some elements of architecture 100 can be disposed in cloud 502 while others are not. By way of example, data store 142, 156, and/or 168 can be disposed outside of cloud 502, and accessed through cloud 502. Regardless of where they are located, they can be accessed directly by systems 102-104, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

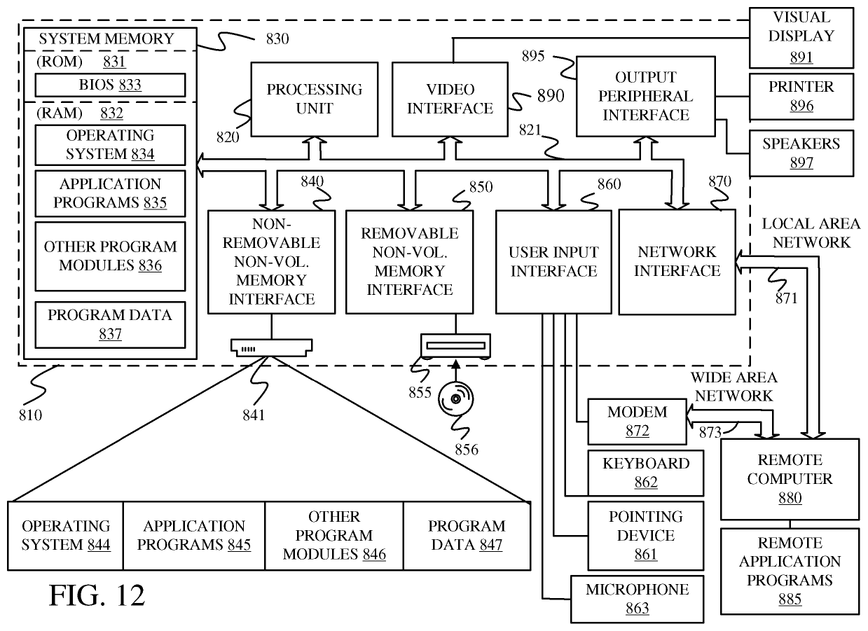

FIG. 12 is one example of a computing environment in which architecture 100, or parts of it, (for example) can be deployed. With reference to FIG. 12, an example system for implementing some examples includes a computing device in the form of a computer 810 programmed to operate as discussed above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 12 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computer implemented method, comprising:
receiving, at a domain name system (DNS), a request from a computing system to access a hosted service;
identifying a routing characteristic of the computing system indicative of a time zone where the computing system is located; and
routing the request to a service endpoint based on the routing characteristic.

Example 2 is the computer implemented method of any or all previous examples wherein identifying a routing characteristic comprises:
identifying the time zone where the computing system is located; and
determining a time corresponding to the request.

Example 3 is the computer implemented method of any or all previous examples wherein the request identifies a domain name corresponding to the hosted service and wherein routing the request comprises:
accessing a routing policy corresponding to the computing system; and
resolving the domain name to an internet protocol (IP) address of the service endpoint, of a plurality of different service endpoints, using the routing policy, based on the time corresponding to the request and the identified time zone.

Example 4 is the computer implemented method of any or all previous examples wherein the computing system is one of a plurality of different computing systems of an organization, and further comprising:
identifying a time zone corresponding to each of the plurality of different computing systems of the organization; and
generating a routing policy for each of the different computing systems based on the time zone corresponding to each of the plurality of different computing systems of the organization.

Example 5 is the computer implemented method of any or all previous examples wherein identifying the time zone corresponding to each of the plurality of different computing systems of the organization comprises:
accessing a geographic footprint for the organization, the geographic footprint identifying a geographic location of each of the plurality of different computing systems of the organization; and
identifying the time zone corresponding to each of the plurality of different computing systems of the organization based on the geographic location of each of the plurality of different computing systems of the organization.

Example 6 is the computer implemented method of any or all previous examples wherein generating a routing policy comprises:
generating a subnet-to-service endpoint pair for each of the plurality of service endpoints, each of the subnet-to-service endpoint pairs being a pair comprising a selected computing system, of the plurality of computing systems of the organization, and a selected service endpoint of the plurality of service endpoints; and
generating a different predictive latency output corresponding to each of the subnet-to-service endpoint pairs, each predictive latency output including a plurality of different latency values, each of the plurality of different latency values corresponding to a different future time interval and identifying a predicted latency encountered by the selected computing system in accessing the service endpoint in the corresponding subnet-to-service endpoint pair during the corresponding future time interval.

Example 7 is the computer implemented method of any or all previous examples wherein generating a routing policy comprises:
for each of the different future time intervals, identifying the subnet-to-service endpoint pair that has a lowest latency value in the corresponding predictive latency output; and
generating the routing policy to identify the service endpoint in the identified subnet-to-service endpoint pair for the corresponding future time interval such that, when a request is received from the selected computing system during the future time interval, the request is routed to the service endpoint identified in the routing policy for the future time interval.

Example 8 is the computer implemented method of any or all previous examples wherein generating a predictive latency output corresponding to each of the plurality of subnet-to-service endpoint pairs comprises:
for each given subnet-to-service endpoint pair, receiving prior subnet-to-service endpoint latency data;
generating a first preliminary predictive output using a first predictive model based on the prior subnet-to-service endpoint latency data;
generating a second preliminary predictive output using a second predictive model based on the prior subnet-to-service endpoint latency data; and
aggregating the first and second preliminary predictive outputs to obtain the predictive latency output.

Example 9 is the computer implemented method of any or all previous examples wherein aggregating comprises:
weighting the first preliminary predictive output with a first weight to obtain a first weighted preliminary predictive output;
weighting the second preliminary predictive output with a second weight to obtain a second weighted preliminary predictive output; and
combining the first and second weighted preliminary predictive outputs to obtain the predictive latency output.

Example 10 is the computer implemented method of any or all previous examples wherein the prior subnet-to-service endpoint latency data comprises a latency encountered by the selected computing system in accessing the service endpoint and a timestamp indicative of when the latency was encountered.

Example 11 is the computer implemented method of any or all previous examples wherein generating a first preliminary predictive output using a first predictive model based on the prior subnet-to-service endpoint latency data comprises:

generating the first preliminary predictive output as a first predictive latency array with different array elements, each different array element identifying latency encountered during a different time period based on the timestamp.

Example 12 is the computer implemented method of any or all previous examples wherein generating a second preliminary predictive output using a second predictive model based on the prior subnet-to-service endpoint latency data comprises:

generating the second preliminary predictive output as a second predictive latency array with different array elements, each different array element identifying latency encountered during a different time period based on the timestamp.

Example 13 is a computer system, comprising:
at least one processor; and
a data store that stores computer executable instructions which, when executed by the at least one processor, causes the at least one processor to perform steps comprising:
obtaining first latency data corresponding to a first computing system of an organization, the first computing system being located in a first time zone, the first latency data indicating latency encountered by the first computing system, at different times of day, in accessing different service endpoints of a service;
obtaining second latency data corresponding to a second computing system of the organization, the second computing system being located in a second time zone, the second latency data indicating latency encountered by the second computing system, at different times of day, in accessing the different service endpoints of the service;
generating a first routing policy for the first computing system based on the first latency data and based on the first computing system being located in the first time zone;
generating a second routing policy for the second computing system based on the second latency data and based on the second computing system being located in the second time zone; and
routing requests to access the service from the first computing system to a service endpoint, of the different service endpoints, based on the first routing policy; and
routing requests to access the service from the second computing system to a service endpoint, of the different service endpoints, based on the second routing policy.

Example 14 is the computer system of any or all previous examples wherein the data store stores computer executable instructions which, when executed by the at least one processor, causes the at least one processor to further perform steps comprising:
accessing a geographic footprint for the organization, the geographic footprint identifying a geographic location of each of the first and second computing systems of the organization; and
identifying the time zone corresponding to each of the first and second computing systems of the organization based on the geographic location of each of the first and second computing systems of the organization.

Example 15 is the computer system of any or all previous examples wherein generating a first routing policy comprises:
generating a subnet-to-service endpoint pair for each of the service endpoints, each of the subnet-to-service endpoint pairs being a pair comprising the first computing system and a selected service endpoint of the different service endpoints; and
generating a different predictive latency output corresponding to each of the subnet-to-service endpoint pairs, each predictive latency output including an array of latency values, each of the latency values corresponding to a different future time interval and identifying a predicted latency encountered by the first computing system in accessing the service endpoint in the corresponding subnet-to-service endpoint pair during the corresponding future time interval.

Example 16 is the computer system of any or all previous examples wherein generating the first routing policy comprises:
for each of the different future time intervals, identifying the subnet-to-service endpoint pair that has a lowest latency value in the corresponding predictive latency output; and
generating the first routing policy to identify the service endpoint in the identified subnet-to-service endpoint pair for the corresponding future time interval.

Example 17 is the computer system of any or all previous examples wherein generating a second routing policy comprises:
generating a subnet-to-service endpoint pair for each of the service endpoints, each of the subnet-to-service endpoint pairs being a pair comprising the second computing system and a selected service endpoint of the different service endpoints; and
generating a different predictive latency output corresponding to each of the subnet-to-service endpoint pairs, each predictive latency output including an array of latency values, each of the latency values corresponding to a different future time interval and identifying a predicted latency encountered by the second computing system in accessing the service endpoint in the corresponding subnet-to-service endpoint pair during the corresponding future time interval.

Example 18 is the computer system of any or all previous examples wherein generating the second routing policy comprises:
for each of the different future time intervals, identifying the subnet-to-service endpoint pair that has a lowest latency value in the corresponding predictive latency output; and
generating the second routing policy to identify the service endpoint in the identified subnet-to-service endpoint pair for the corresponding future time interval.

Example 19 is a computer system, comprising:
a domain name system (DNS) routing policy generation system generating a first routing policy for a first computing system of an organization based on a time zone where the first computing system is located and generating a second routing policy for a second computing system of the organization based on a time zone where the second computing system is located; and
a DNS service receiving a request from the first computing system to access a hosted service and routing the request to an endpoint of the hosted service using the first routing policy and receiving a request from the second computing system to access the hosted service and routing the request to an endpoint of the hosted service using the second routing policy.

Example 20 is the computer system of any or all previous examples the request from the first computing system has a corresponding timestamp and wherein the DNS service routes the request from the first computing system based on the first routing policy and based on timestamp corresponding to the request.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
receiving, at a domain name system (DNS), a request from a computing system to access a hosted service;
identifying a routing characteristic of the computing system indicative of a time zone where the computing system is located; and
routing the request to a service endpoint based on the routing characteristic.

2. The computer implemented method of claim 1 wherein identifying a routing characteristic comprises:
identifying the time zone where the computing system is located; and
determining a time corresponding to the request.

3. The computer implemented method of claim 2 wherein the request identifies a domain name corresponding to the hosted service and wherein routing the request comprises:
accessing a routing policy corresponding to the computing system; and
resolving the domain name to an internet protocol (IP) address of the service endpoint, of a plurality of different service endpoints, using the routing policy, based on the time corresponding to the request and the identified time zone.

4. The computer implemented method of claim 3 wherein the computing system is one of a plurality of different computing systems of an organization, and further comprising:
identifying a time zone corresponding to each of the plurality of different computing systems of the organization; and
generating a routing policy for each of the different computing systems based on the time zone corresponding to each of the plurality of different computing systems of the organization.

5. The computer implemented method of claim 4 wherein identifying the time zone corresponding to each of the plurality of different computing systems of the organization comprises:
accessing a geographic footprint for the organization, the geographic footprint identifying a geographic location of each of the plurality of different computing systems of the organization; and
identifying the time zone corresponding to each of the plurality of different computing systems of the organization based on the geographic location of each of the plurality of different computing systems of the organization.

6. The computer implemented method of claim 4 wherein generating a routing policy comprises:
generating a subnet-to-service endpoint pair for each of the plurality of service endpoints, each of the subnet-to-service endpoint pairs being a pair comprising a selected computing system, of the plurality of computing systems of the organization, and a selected service endpoint of the plurality of service endpoints; and
generating a different predictive latency output corresponding to each of the subnet-to-service endpoint pairs, each predictive latency output including a plurality of different latency values, each of the plurality of different latency values corresponding to a different future time interval and identifying a predicted latency encountered by the selected computing system in accessing the service endpoint in the corresponding subnet-to-service endpoint pair during the corresponding future time interval.

7. The computer implemented method of claim 6 wherein generating a routing policy comprises:
for each of the different future time intervals, identifying the subnet-to-service endpoint pair that has a lowest latency value in the corresponding predictive latency output; and
generating the routing policy to identify the service endpoint in the identified subnet-to-service endpoint pair for the corresponding future time interval such that, when a request is received from the selected computing system during the future time interval, the request is routed to the service endpoint identified in the routing policy for the future time interval.

8. The computer implemented method of claim 7 wherein generating a predictive latency output corresponding to each of the plurality of subnet-to-service endpoint pairs comprises:
for each given subnet-to-service endpoint pair, receiving prior subnet-to-service endpoint latency data;
generating a first preliminary predictive output using a first predictive model based on the prior subnet-to-service endpoint latency data;
generating a second preliminary predictive output using a second predictive model based on the prior subnet-to-service endpoint latency data; and
aggregating the first and second preliminary predictive outputs to obtain the predictive latency output.

9. The computer implemented method of claim 8 wherein aggregating comprises:
weighting the first preliminary predictive output with a first weight to obtain a first weighted preliminary predictive output;
weighting the second preliminary predictive output with a second weight to obtain a second weighted preliminary predictive output; and
combining the first and second weighted preliminary predictive outputs to obtain the predictive latency output.

10. The computer implemented method of claim 9 wherein the prior subnet-to-service endpoint latency data comprises a latency encountered by the selected computing system in accessing the service endpoint and a timestamp indicative of when the latency was encountered.

11. The computer implemented method of claim 10 wherein generating a first preliminary predictive output using a first predictive model based on the prior subnet-to-service endpoint latency data comprises:
generating the first preliminary predictive output as a first predictive latency array with different array elements, each different array element identifying latency encountered during a different time period based on the timestamp.

12. The computer implemented method of claim 11 wherein generating a second preliminary predictive output using a second predictive model based on the prior subnet-to-service endpoint latency data comprises:
generating the second preliminary predictive output as a second predictive latency array with different array elements, each different array element identifying latency encountered during a different time period based on the timestamp.

13. A computer system, comprising:
at least one processor; and
a data store that stores computer executable instructions which, when executed by the at least one processor, causes the at least one processor to perform steps comprising:
obtaining first latency data corresponding to a first computing system of an organization, the first computing system being located in a first time zone, the first latency data indicating latency encountered by the first computing system, at different times of day, in accessing different service endpoints of a service;
obtaining second latency data corresponding to a second computing system of the organization, the second computing system being located in a second time zone, the second latency data indicating latency encountered by the second computing system, at different times of day, in accessing the different service endpoints of the service;
generating a first routing policy for the first computing system based on the first latency data and based on the first computing system being located in the first time zone;
generating a second routing policy for the second computing system based on the second latency data and based on the second computing system being located in the second time zone; and
routing requests to access the service from the first computing system to a service endpoint, of the different service endpoints, based on the first routing policy; and
routing requests to access the service from the second computing system to a service endpoint, of the different service endpoints, based on the second routing policy.

14. The computer system of claim 13 wherein the data store stores computer executable instructions which, when executed by the at least one processor, causes the at least one processor to further perform steps comprising:
accessing a geographic footprint for the organization, the geographic footprint identifying a geographic location of each of the first and second computing systems of the organization; and
identifying the time zone corresponding to each of the first and second computing systems of the organization based on the geographic location of each of the first and second computing systems of the organization.

15. The computer system of claim 13 wherein generating a first routing policy comprises:
generating a subnet-to-service endpoint pair for each of the service endpoints, each of the subnet-to-service endpoint pairs being a pair comprising the first computing system and a selected service endpoint of the different service endpoints; and
generating a different predictive latency output corresponding to each of the subnet-to-service endpoint pairs, each predictive latency output including an array of latency values, each of the latency values corresponding to a different future time interval and identifying a predicted latency encountered by the first computing system in accessing the service endpoint in the corresponding subnet-to-service endpoint pair during the corresponding future time interval.

16. The computer system of claim 15 wherein generating the first routing policy comprises:
for each of the different future time intervals, identifying the subnet-to-service endpoint pair that has a lowest latency value in the corresponding predictive latency output; and
generating the first routing policy to identify the service endpoint in the identified subnet-to-service endpoint pair for the corresponding future time interval.

17. The computer system of claim 13 wherein generating a second routing policy comprises:
generating a subnet-to-service endpoint pair for each of the service endpoints, each of the subnet-to-service endpoint pairs being a pair comprising the second computing system and a selected service endpoint of the different service endpoints; and
generating a different predictive latency output corresponding to each of the subnet-to-service endpoint pairs, each predictive latency output including an array of latency values, each of the latency values corresponding to a different future time interval and identifying a predicted latency encountered by the second computing system in accessing the service endpoint in the corresponding subnet-to-service endpoint pair during the corresponding future time interval.

18. The computer system of claim 17 wherein generating the second routing policy comprises:
for each of the different future time intervals, identifying the subnet-to-service endpoint pair that has a lowest latency value in the corresponding predictive latency output; and
generating the second routing policy to identify the service endpoint in the identified subnet-to-service endpoint pair for the corresponding future time interval.

19. A computer system, comprising:
a domain name system (DNS) routing policy generation system generating a first routing policy for a first computing system of an organization based on a time zone where the first computing system is located and generating a second routing policy for a second computing system of the organization based on a time zone where the second computing system is located; and
a DNS service receiving a request from the first computing system to access a hosted service and routing the request to an endpoint of the hosted service using the first routing policy and receiving a request from the second computing system to access the hosted service and routing the request to an endpoint of the hosted service using the second routing policy.

20. The computer system of claim 19 the request from the first computing system has a corresponding timestamp and wherein the DNS service routes the request from the first computing system based on the first routing policy and based on timestamp corresponding to the request.
